(19) United States
(12) Patent Application Publication
(10) Pub. No.: US 2011/0113688 A1
(43) Pub. Date: May 19, 2011

(54) REFORMING APPARATUS

(75) Inventors: Koichi Kuwaba, Nagoya-shi (JP); Satoshi Endo, Nagoya-shi (JP); Hitoshi Yoshiguchi, Okazaki-shi (JP)

(73) Assignee: TOYOTA JIDOSHA KABUSHIKI KAISHA, Toyota-shi (JP)

(21) Appl. No.: 12/933,244

(22) PCT Filed: Mar. 17, 2009
(86) PCT No.: PCT/IB2009/000530

§ 371 Date: Sep. 17, 2010

(30) Foreign Application Priority Data
Mar. 18, 2008 (JP) 2008-070137

(51) Int. Cl. C10J 3/46; B01J 19/00

(52) U.S. Cl. 48/197 R; 422/198

(57) ABSTRACT

A reforming apparatus includes: an evaporation part that heats reforming water to generate steam; a reforming part having a reforming catalyst that is supplied with a mixture of the steam generated by the evaporation part and reforming fuel and generates reforming gas; a mixing part that is disposed on the lower side of the reforming part in the gravity direction and mixes the reforming fuel with the steam; a reforming fuel supply pipe having a desulfurizer for removing a sulfur content of the reforming fuel; and a reforming fuel connecting pipe connected at one end to the reforming fuel supply pipe and opened at the other end to the mixing part. A connecting part between the reforming fuel supply pipe and the reforming fuel connecting pipe is disposed above the mixing part in the gravity direction.

### BACKGROUND OF THE INVENTION

1. Field of the Invention

This invention relates to a reforming apparatus.

2. Description of the Related Art

The device of a related art that is shown in FIG. 1 of Japanese Patent Application Publication No. 2004-171892 (JP-A-2004-171892) has been available as a way to inject a reforming fuel by means of a reforming apparatus for fuel cell in which a reformer, CO transformer and CO remover are integrated together. The reforming fuel and steam are mixed on the upper side of the gravity direction of the integrated reforming apparatus for fuel cell, and the mixture is injected toward the lower side of the gravity direction. In this manner, the structure of this apparatus can be made simple and small.

However, as in this system, in the structure of a reformer in which steam and reforming fuel are injected from the upper side of the gravity direction of a reforming catalyst, the drain water that is generated in a path of the steam and reforming fuel might fall down toward the lower side of the gravity direction and flow into the reforming catalyst after the operation is stopped. As a result, the performing of the reforming catalyst could be deteriorated significantly. However, if the reformer is so structured that the steam is injected from the lower side of the gravity direction of the reforming catalyst in order to resolve the above-described problem, reforming water might flow into a reforming fuel line, and consequently damage and deteriorate the performance of desulfurizer provided in the reforming fuel line.

### SUMMARY OF THE INVENTION

This invention provides a highly reliable reforming apparatus that reduces the possibility of flow of water into the reforming catalyst as well as the possibility of deterioration of the performance of the desulfurizer caused by water flowing into the reforming fuel line.

A first aspect of the invention relates to a reforming apparatus having: an evaporation part that heats reforming water to generate steam; a mixing part that mixes reforming fuel with the steam; a reforming part having a reforming catalyst that is supplied with the reforming fuel mixed with the steam and generates reforming gas from the supplied reforming fuel, and disposed on the upper side of the mixing part in a gravity direction; a reforming fuel supply pipe that has a desulfurizer for removing a sulfur content of the reforming fuel; and a reforming fuel connecting pipe that is connected at one end to the reforming fuel supply pipe and opened at the other end to the mixing part. In this reforming apparatus, a connecting part between the reforming fuel supply pipe and the reforming fuel connecting pipe is disposed above the mixing part in the gravity direction.

According to this configuration, even if by any chance the reforming water enters from the other end of the reforming fuel connecting pipe that is opened to the mixing part, it is possible to reduce the possibility that the reforming water flows back to the reforming fuel supply pipe beyond the connecting part and flows into the desulfurizer in an upstream of the reforming fuel supply pipe. As a result, the possibility of damage to a desulfurizing material caused by the water can be reduced, improving the reliability of the apparatus. Moreover, the risk of deterioration caused by the water can be lowered, increasing the degree of freedom for disposing the desulfurizer for the reforming fuel. Therefore, the desulfurizer can be freely disposed in a place where it can be maintained well, improving merchantability. In addition, a steam feed port and a reforming fuel input port on the other end of the reforming fuel connecting pipe are opened to the mixing part disposed on the upper side of the gravity direction of the reforming part having the reforming catalyst. Therefore, the possibility that the drain water that is generated in the reforming fuel connecting pipe or a steam supply pipe falls down into the reforming catalyst after the operation is stopped can be reduced, and thus the possibility of deterioration of the reforming catalyst is also reduced, improving the reliability of the apparatus.

In the reforming apparatus according to this aspect, a pool part that accumulates water supplied along with the steam and/or water obtained by liquefying the steam may be provided on the lower side of the mixing part in the gravity direction.

According to this configuration, water supplied along with the steam and/or water obtained by liquefying the steam falls down by gravity and accumulates in the mixing part. As a result, the water in the pool part flows into the reforming fuel input port that is provided on the other end of the reforming fuel connecting pipe and opened to the mixing part disposed on the upper side of the gravity direction of the pool part, so that the water can be prevented from flowing backward into the desulfurizer through the upstream of the reforming fuel supply pipe. Consequently, the possibility of damage to the desulfurizing material can be reduced, improving the reliability of the apparatus.

In the reforming apparatus according to this aspect, the reforming fuel input port of the reforming fuel connecting pipe that is opened to the mixing part may be disposed above the pool part in the gravity direction.

This configuration can reduce the possibility that the water accumulated in the pool part flows back into the desulfurizer via the upstream of the reforming fuel supply pipe via the reforming fuel input port. As a result, the possibility of damage to the desulfurizing material can be reduced, improving the reliability of the apparatus.

In the reforming apparatus according to this aspect, a carbon monoxide reduction part which is fed with the reforming gas from the reforming part to reduce carbon monoxide of the reforming gas may be disposed below the pool part in the gravity direction, and an upper part of the carbon monoxide reduction part may abut against the pool part.

According to this configuration, the heat of the carbon monoxide reduction part evaporates the water of the pooling part abutting against the upper part of the carbon monoxide reduction part, whereby the steam can be generated easily, improving the heat transfer efficiency. Moreover, the water accumulated in the pool part can easily reduce the temperature of the carbon monoxide reduction part so that the inlet temperature of the carbon monoxide reduction part can be brought close to the temperature at which a shift reaction takes place efficiently, improving the shift reaction efficiency.

A second aspect of the invention relates to a reforming apparatus having: an evaporation part that heats reforming water to generate steam; a mixing part that mixes reforming fuel with the steam; a reforming part having a reforming catalyst that is supplied with the reforming fuel mixed with the steam and generates reforming gas from the supplied reforming fuel, and disposed on the upper side of the mixing part in a gravity direction; and a reforming fuel supply pipe that has a desulfurizer for removing a sulfur content of the reforming fuel and supplies the reforming fuel to the mixing part. In this reforming apparatus, a reforming fuel input port of the reforming fuel supply pipe that is opened to the mixing part is disposed, in the gravity direction, above a feed port of the steam supply pipe that is opened to the mixing part.

This configuration can reduce the possibility that the reforming water flows backward through the reforming fuel supply pipe via the reforming fuel input port and flows into the desulfurizer disposed in an upstream of the reforming fuel supply pipe. As a result, the possibility of damage to a desulfurizing material caused by the water can be lowered, improving the reliability of the apparatus. Moreover, because the degree of freedom for disposing the desulfurizer increases as a result of the reduced risk of deterioration of the desulfurizer, the desulfurizer can be freely disposed in a place where it can be maintained well, improving merchantability.

In addition, a feed port for the steam guided to the steam supply pipe is opened to the mixing port disposed on the lower side of the gravity direction of the reforming part having the reforming catalyst, and the reforming fuel input port of the reforming fuel supply pipe that is opened to the mixing port is disposed on the upper side of the gravity direction of the feed port of the steam supply pipe. Therefore, the drain water that is generated in the reforming fuel supply pipe or the steam supply pipe is unlikely to fall down into the reforming catalyst after the operation is stopped, and thus the possibility of deterioration of the reforming catalyst can be reduced, improving the reliability of the apparatus.

In the reforming apparatus according to this aspect, a pool part that accumulates water supplied along with the steam and/or water obtained by liquefying the steam may be provided on the lower side of the gravity direction of the mixing part.

According to this configuration, water supplied along with the steam and/or water obtained by liquefying the steam falls down by gravity and accumulates in the mixing part. As a result, the water in the pool part flows from the feed port of the steam supply pipe that is opened to the mixing part disposed on the upper side of the gravity direction of the pool part, into the reforming fuel input port of the reforming fuel supply pipe that is opened to the mixing part disposed on the upper side of the gravity direction, so that the water can be prevented from flowing into the desulfurizer in the upstream. Consequently, the possibility of damage to the desulfurizing material can be reduced, improving the reliability of the apparatus.

In the reforming apparatus according to this aspect, the reforming fuel input port of the reforming fuel supply pipe that is opened to the mixing part may be disposed above the pool part in the gravity direction.

This configuration can reduce the possibility that the water accumulated in the pool part flows back into the desulfurizer via the upstream of the reforming fuel supply pipe via the reforming fuel input port. As a result, the possibility of damage to the desulfurizing material can be reduced, improving the reliability of the apparatus.

In the reforming apparatus according to this aspect, a carbon monoxide reduction part which is fed with the reforming gas from the reforming part to reduce carbon monoxide of the reforming gas may be disposed below the pool part in the gravity direction, and an upper part of the carbon monoxide reduction part may abut against the pool part.

According to this configuration, the heat of the carbon monoxide reduction part evaporates the water of the pooling part abutting against the upper part of the carbon monoxide reduction part, whereby the steam can be generated easily, improving the heat transfer efficiency. Moreover, the water accumulated in the pool part can easily reduce the temperature of the carbon monoxide reduction part so that the inlet temperature of the carbon monoxide reduction part can be brought close to the temperature at which a shift reaction takes place efficiently, improving the shift reaction efficiency.

A third aspect of the invention relates to a reforming apparatus having: an evaporation part that heats reforming water to generate steam; a mixing part that is supplied with a reforming fuel and the steam and then mixes the reforming fuel and the steam; a reforming part that is disposed on the upper side of the mixing part in a gravity direction, and has a reforming catalyst that is supplied with the reforming fuel mixed with the steam and generates reforming gas from the reforming fuel mixed with the steam; a desulfurizer that removes a sulfur content of the reforming fuel; and a communication path that communicates the desulfurizer and the mixing part with each other via a position above a position where the steam is supplied to the mixing part, in the gravity direction. In this reforming apparatus, the reforming fuel from which the sulfur content is removed is supplied to the mixing part via the communication path.

The reforming apparatus according to this aspect may further have a steam supply pipe for supplying the steam obtained by the evaporation part to the mixing part. The position in the gravity direction that is above a position where the steam is supplied to the mixing part may be a position where the reforming fuel is supplied in the mixing part.

In the reforming apparatus according to this aspect, a pool part for accumulating water may be provided in the mixing part below a position where the steam is supplied and a position where the reforming fuel is supplied, in the gravity direction.

The reforming apparatus according to this aspect may further have a carbon monoxide reduction part which is disposed below the pool part in the gravity direction, an upper part of which abuts against the pool part, and which feeds the reforming gas from the reforming part to reduce carbon monoxide of the reforming gas.

The reforming apparatus according to the first, second or third aspect may further have a cooling part which is provided between the reforming part and the carbon monoxide reduction part, cools the reforming gas fed from the reforming part to the carbon monoxide reduction part, and heats mixed gas of the reforming fuel and the steam that are mixed in the mixing part and supplied to the reforming part. The mixing part may be provided between the cooling part and the carbon monoxide reduction part.

This configuration can form a simple configuration of a system that uses the reforming gas of relatively high temperature to increase the temperature of the mixed gas of the reforming fuel and the steam that is supplied to the reforming part having relatively high reaction temperature, and that also uses the mixed gas of relatively low temperature that is a mixture of the reforming fuel and the steam, to reduce the temperature of the reforming gas supplied to the carbon monoxide reduction part having relatively low reaction temperature. As a result, cost reduction can be achieved.

A fourth aspect of the invention relates to a reforming fuel supply method of a reforming apparatus having: an evaporation part that heats reforming water to generate steam; a mixing part that is supplied with a reforming fuel and the steam and then mixes the reforming fuel and the steam; a reforming part that is disposed on the upper side of the mixing part in a gravity direction, and has a reforming catalyst that is supplied with the reforming fuel mixed with the steam and generates reforming gas from the reforming fuel mixed with the steam; a desulfurizer that removes a sulfur content of the reforming fuel. The reforming fuel supply method includes: communicating the desulfurizer with the mixing part via a position above the position in the gravity direction where the steam is supplied to the mixing part; and supplying the reforming fuel from which the sulfur content is removed, to the mixing part by communicating the desulfurizer with the mixing part.

### BRIEF DESCRIPTION OF THE DRAWINGS

The foregoing and further objects, features and advantages of the invention will become apparent from the following description of example embodiments with reference to the accompanying drawings, wherein like numerals are used to represent like elements and wherein:

FIG. 1 is a schematic diagram showing an overview of a fuel cell system according to a first embodiment of the invention;

FIG. 2 is an enlarged cross-sectional diagram of an X part shown in FIG. 1;

FIG. 3 is a schematic diagram showing an overview of a fuel cell system according to a second embodiment of the invention; and

FIG. 4 is an enlarged cross-sectional diagram of a Y part shown in FIG. 3.

### DETAILED DESCRIPTION OF EMBODIMENTS

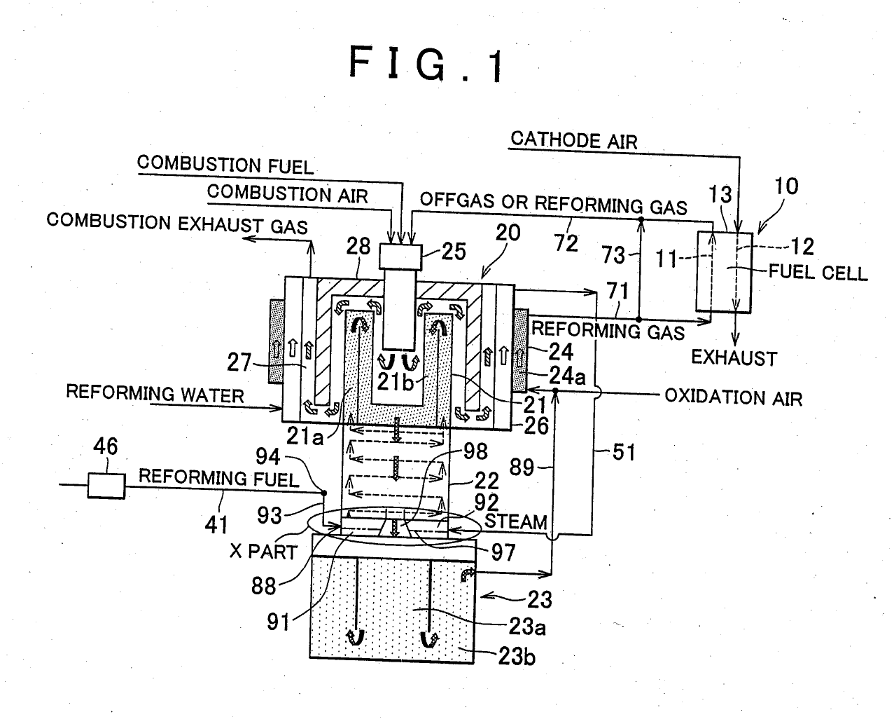

A first embodiment of the reforming apparatus of the invention is described hereinafter. FIG. 1 is a schematic diagram showing an overview of a fuel cell system having this reforming apparatus. This fuel cell system has a fuel cell 10 and a reforming apparatus 20 that generates reforming gas containing hydrogen gas required by the fuel cell 10.

The fuel cell 10 has a fuel electrode 11, an air electrode 12 which is an oxidant electrode, and an electrolyte 13 lying between the electrodes 11 and 12, and generates electricity using air (cathode air) which is reforming gas supplied to the fuel electrode 11 and oxidant gas supplied to the air electrode 12.

The reforming apparatus 20 steam-reforms reforming fuel and supplies hydrogen-rich reforming gas to the fuel cell 10, and is configured by a reforming part 21, cooling part 22, carbon monoxide reduction part (to be referred to as “CO shift part” hereinafter) 23, carbon monoxide selective oxidation reaction part (to be referred to as “CO selective oxidation part” hereinafter) 24, combustion part 25, and an evaporation part 26. As the reforming fuel, there are reforming gaseous fuel such as natural gas and LPG, and reforming liquid fuel such as kerosene, gasoline and methanol, and natural gas is described in this embodiment.

Mixed gas that is obtained by inputting the reforming fuel into steam generated by heating reforming water in the evaporation part 26 is fed to the reforming part 21, and thereby reforming gas is generated and guided out. This reforming part 21 is formed into a bottomed cylinder, and has a circular return passage 21a that extends along an axis line of a circular cylinder part.

The return passage 21a of the reforming part 21 is filled with a catalyst 21b (for example, Ru or Ni catalyst). The mixed gas of the reforming fuel and the steam fed from a steam supply pipe 51 is heated in the cooling part 22, fed into the return passage 21a, and reacted and reformed by the catalyst 21b, whereby hydrogen gas and carbon monoxide gas are generated (so-called a steam-reforming reaction). At the same time the carbon monoxide and the steam that are generated by the steam-reforming reaction are reacted and altered to hydrogen gas and carbon dioxide, whereby a so-called a carbon monoxide shift reaction is generated. The generated gas (so-called reforming gas) is guided out to the cooling part (heat exchanging part) 22. Note that the steam-reforming reaction is an endothermic reaction, and the carbon monoxide shift reaction an exothermic reaction.

The cooling part 22, disposed between the reforming part 21 and the CO shift part 23, is a heat exchanger (heat exchanging part) in which heat exchange is performed between the reforming gas generated and guided out by the reforming part 21 and the mixed gas of the reforming fuel and the reforming water (steam). The cooling part 22 cools the high-temperature reforming gas by means of the low-temperature mixed gas and guided it out to the CO shift part 23, and heats the mixed gas by means of the reforming gas and guided it out to the reforming part 21.

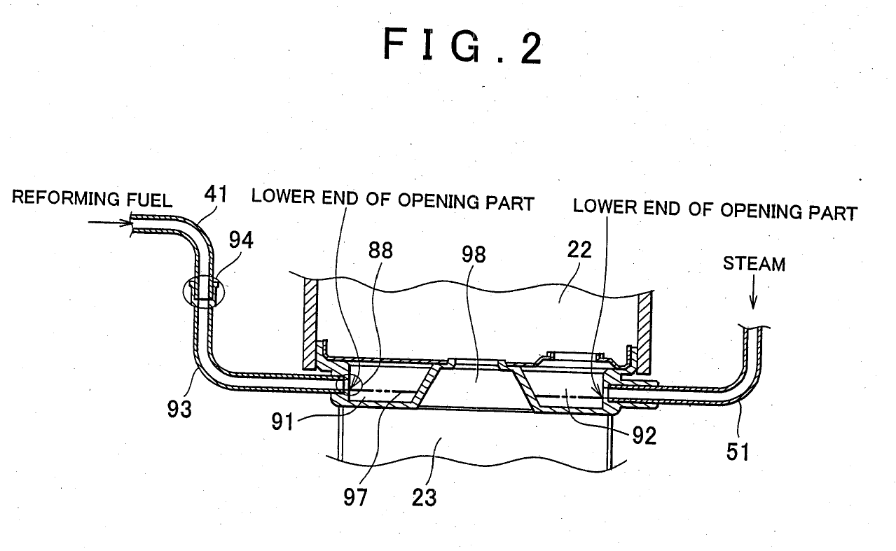

A mixing part 92 is disposed between the cooling part 22 and the CO shift part 23. The mixing part 92 is connected to one end of the steam supply pipe 51 connected to the evaporation part 26 at the other end. The one end of the steam supply pipe 51 is opened so that steam and water are supplied from the evaporation part 26 to the mixing part 92. The mixing part 92 is connected to one , end of a reforming fuel connecting pipe 93 that is connected to a reforming fuel supply pipe 41 one end of which is connected to a fuel supply source (for example, a city gas pipe). Accordingly, a reforming fuel input port 88 is opened so that the reforming fuel is supplied therefrom and mixed with the steam. A lower part of the mixing part 92 in a gravity direction thereof is provided with a pool part 91 for accumulating the water supplied along with the steam from the evaporation part 26 via the steam supply pipe 51. The height of the pool part 91 is set by obtaining the maximum amount of the water to be accumulated by using demonstration data, and then obtaining a volume that can accumulate the maximum amount obtained based on the data. The pool part 91 projects downward from a bottom part of the mixing part 92 in the gravity direction, the mixing part 92 being disposed on the lower side of the reforming part 21 with the reforming catalyst in the gravity direction. As shown in FIG. 2, a space 98 penetrating vertically in the gravity direction is provided in the center between the mixing part 92 and the pool part 91 so that the reforming gas generated in the reforming part 21 is guided out to the CO shift part 23. An upper section of a circular space formed circularly around a rim part of the penetrating space 98 in the gravity direction configures the mixing part 92, while a lower section configures the pool part 91 and abuts against the CO shift part 23.

The connection position between the steam supply pipe 51 and the mixing part 92 is formed such that a lower end of an opening part of the steam supply pipe 51 opened to the mixing part 92 in the gravity direction is positioned above an upper end (two-dot chain line) 97 of the pool part 91 in the gravity direction. The connection position between the reforming fuel connecting pipe 93 and the mixing part 92 is formed on substantially the same level as the steam supply pipe 51 such that a lower end of the reforming fuel input port 88 of the reforming fuel connecting pipe 93 that is opened to the mixing part 92 in the gravity direction is positioned above the upper end (two-dot chain line) 97 of the pool part 91 in the gravity direction (FIG. 2). Then, the mixed gas of the steam and the reforming fuel that is obtained in the mixing part 92 is supplied to the reforming part 21 via the cooling part 22.

The reforming fuel connecting pipe 93 is horizontally extended predetermined distance from the connection with the mixing part 92 in a direction in which the reforming fuel connecting pipe 93 separates from the central axis of the cooling part 22. The reforming fuel connecting part 93 is then bent orthogonally upward in the gravity direction and then extended a predetermined distance to open a connecting part 94 on the upper side in the gravity direction. The reforming fuel supply pipe 41 is connected to an opening part of the connecting part 94. At this moment the connecting part 94 is disposed above the mixing part 92 in the gravity direction. The reforming fuel connecting pipe 93 may be bent in the horizontal direction again and connected to the reforming fuel supply pipe 41, with the connecting part 94 opened in the horizontal direction. The reforming fuel connecting pipe 93 and the reforming fuel supply pipe 41 are so connected that leakage of the reforming fuel is not caused by unshown predetermined means at the connecting part 94. The upstream of the reforming fuel supply pipe 41 is provided with a desulfurizer 46 for removing a sulfur content within the fuel (for example, sulfur compound).

The CO shift part 23 reduces the carbon monoxide contained in the reforming gas cooled by the cooling part 22 and supplied from the reforming part 21 via the central space 98 between the mixing part 92 and the pool part 91. The inside of the CO shift part 23 has, in the gravity direction, a return passage 23a that extends along a vertical direction. The return passage 23a is filled with a catalyst 23b (for example, Cu—Zn catalyst). In the CO shift part 23, the carbon monoxide and the steam that are contained in the reforming gas fed from the cooling part 22 are reacted and altered to hydrogen gas and carbon dioxide by the catalyst 23b, whereby a so-called a carbon monoxide shift reaction is generated. The carbon monoxide shift reaction is an exothermic reaction.

The CO selective oxidation part 24 further reduces the carbon monoxide within the reforming gas supplied from the CO shift part 23 via a connecting pipe 89 and then supplies the reduced carbon monoxide to the fuel cell 10. The CO selective oxidation part 24 is formed into a cylinder and abuts against the evaporation part 26 so as to cover an outer wall thereof. The CO selective oxidation part 24 is filled with a catalyst 24a (for example, Ru or Pt catalyst). The reforming gas supplied to the CO selective oxidation part 24 is mixed with oxidation air. The oxidation air is mixed with the reforming gas supplied from the CO shift part 23, and thus obtained mixture is supplied to the CO selective oxidation part 24.

Therefore, the carbon monoxide of the reforming gas fed into the CO selective oxidation part 24 reacts with the oxygen within the oxidation air (oxidized) and turns into carbon dioxide. This reaction is the exothermic reaction facilitated by the catalyst 24a. As a result, the reforming gas is guided out after the concentration of the carbon monoxide within reforming gas is reduced by the reaction (10 ppm or lower), and is then supplied to the fuel electrode 11 of the fuel cell 10. The combustion part 25 is connected to a guide port of the fuel electrode 11 via an offgas supply pipe 72. A bypass pipe 73 bypasses the fuel cell 10 and directly links the reforming gas supply pipe 71 and the offgas supply pipe 72 to each other. Moreover, a cathode air supply pipe is connected to an feed port of the air electrode 12 of the fuel cell 10, and a discharge pipe to a guide port of the air electrode 12.

The combustion port 25 generates combustion gas for heating the reforming part 21 and supplying heat required for the steam-reforming reaction. A lower end part of the combustion part 25 is inserted into an inner peripheral wall of the reforming part 21. The combustion gas communicates through a combustion gas passage 27 and discharged as a combustion exhaust gas through the discharge pipe. Accordingly, the combustion gas heats the reforming part 21 and the evaporation part 26 in this order. The combustion gas passage 27 is formed along the inner peripheral wall of the reforming part 21 and folded to come between an outer peripheral wall of the reforming part 21 and an inner peripheral wall of a heat insulating part 28. The combustion gas passage 27 is then folded again to come between an outer peripheral wall of the heat insulating part 28 and an inner peripheral wall of the evaporation part 26.

This combustion part 25 is supplied with combustion fuel. The combustion part 25 is also supplied with the reforming gas from the reforming apparatus 20 upon starting operation of the fuel cell 10, and supplied with anode offgas gas (reforming gas containing hydrogen that is not used in the fuel electrode 11 or unreformed fuel to be reformed by the reforming part) discharged from the fuel cell 10 during steady operation of the fuel cell 10. The combustion part 25 is further supplied with combustion air which is combustion oxidation gas for combusting the combustion fuel, reforming gas, or anode offgas. When the combustion part 25 is ignited, the combustion fuel, reforming gas, or anode offgas that is supplied to the combustion part 25 is combusted and consequently high-temperature combustion gas is generated.

In addition, when the amount of combustion heat generated by the reforming gas or anode offgas is not sufficient to heat the reforming part to a predetermined temperature during generation operation, and the combustion heat is additionally supplied in an amount equivalent to the insufficient amount of combustion heat in order to compensate for this insufficient amount. The system for compensating for the insufficient heat quantity with not only the anode offgas but also the combustion fuel in the combustion part 25 as described above is called “reheating system.” Note that the fuel cell system has not only this reheating system but also a non-reheating system for supplying only the anode offgas to the combustion part 25 during the generation operation without additionally supplying the combustion fuel or other combustible gas as in the reheating system. The invention can be applied to both the reheating system and non-reheating system.

The evaporation part 26 formed into a cylinder forms an outer peripheral wall of the combustion gas passage 27, and the steam supply pipe 51 is connected an upper part of the evaporation part 26. The reforming water fed from a reforming water tank is heated by the heat generated from the combustion gas and the heat generated by the CO selective oxidation part 24 while circulating the inside of the evaporation part 26. As a result, the reforming water turns into steam and guided out to the reforming part 21 via the steam supply pipe 51 and the cooling part 22.

Next, the operation of the fuel cell system is described. Once the starting operation is started, the combustion air and the combustion fuel are supplied to the combustion part 25 based on an instruction from a control device, and then combusted. After a predetermined amount of water is supplied to the evaporation part 26, supply of water is stopped once. Thereafter, when the temperature of the evaporation part 26 becomes a predetermined value (for example, 100° C.) or more, it is determined that steam is generated, and a predetermined amount of water is supplied to the evaporation part 26 again. The reforming water fed to the evaporation part 26 is supplied such that an upper and of water surface is positioned below the connection of the steam supply part 51 connected to the upper part of the evaporation part 26, in the gravity direction, whereby steam generated on a reforming water interface is generated. The steam generated by the evaporation part 26 is guided to the steam supply pipe 51 along with water scattered by a boiling action, and then fed to the mixing part 92 positioned below the cooling part 22 in the gravity direction. As a result, the water is accumulated in the pool part 91. Here, the pool part 91 functions as the evaporation part, and the reforming water evaporates also from the interface of the water accumulated in the pool part 91 as well, and guided out to the cooling part. At this moment, lower ends in the gravity direction of the opening parts of the steam supply pipe 51 and the reforming fuel connecting pipe 93 that are opened to the mixing part 92 are disposed above the upper end 97 of the pool part 91 in the gravity direction. Therefore, the possibility that the reforming water flows back into the steam supply pipe 51 or flows into the reforming fuel connecting pipe 93 is low. If by any chance the reforming water flows into the reforming fuel connecting pipe 93, the reforming fuel connecting pipe 93 is horizontally extended a predetermined distance from the connection with the mixing part 92 in a direction in which the reforming fuel connecting pipe 93 separates from the central axis of the cooling part 22. The reforming fuel connecting part 93 is then bent orthogonally upward extended a predetermined distance to open the connecting part 94 on the upper side in the gravity direction of the mixing part 92. The opening part of the connecting part 94 is connected to the reforming fuel supply pipe 41. Therefore, the possibility that the reforming water flows into the reforming fuel supply pipe 41 and then into the desulfurizer 46 provided in the upstream of the reforming fuel supply pipe 41 can be reduced.

Thereafter, when the temperature of the reforming part 21 increases to a predetermined temperature, the reforming fuel is supplied to the mixing part 92 via the reforming fuel supply pipe 41 and the reforming fuel connecting pipe 93 and mixed with the steam. The mixed gas of the reforming fuel and the steam is heated by the cooling part 22, which is then fed to the reforming part 21. Then, the abovementioned steam reforming reaction and the carbon monoxide shift reaction take places, thereby generating the reforming gas. The high-temperature reforming gas guided out from the reforming part 21 is supplied to the CO shift part 23 via the cooling part 22, and the concentration of the carbon monoxide contained in the reforming gas is reduced. The reforming gas further passes through the CO shift part 23 and guided out after the concentration of the carbon monoxide of the reforming gas is reduced in the CO selective oxidation part 24 by the oxidation air that is supplied to the CO selective oxidation part 24, simultaneously with the supply of the reforming fuel is started.

Between the start of the fuel cell system and the start of electric power generation, the reforming gas having high concentration of carbon monoxide is prevented from being supplied to the fuel cell 10, and thus the reforming gas is supplied to the combustion part 25 through the bypass pipe 72 without passing through the fuel cell 10. Upon the operation after the start of the electric power generation, the bypass pipe 73 is closed, and the reforming gas supply pipe 71, fuel cell 10, offgas supply pipe 72, and combustion part 25 are communicated with one another. At this moment, the fuel cell 10 is supplied with the reforming gas from the reforming apparatus 20, and the anode offgas is supplied to the combustion part 25 through the offgas supply pipe 72. Also, the air electrode 12 of the, fuel cell 10 is supplied with the air from the cathode air supply pipe.

As is clear from the above description, in the first embodiment, the reforming fuel connecting pipe 93 is horizontally extended a predetermined distance from the connection with the mixing part 92 in a direction in which the reforming fuel connecting pipe 93 separates from the central axis of the cooling part 22. The reforming fuel connecting part 93 is then bent orthogonally upward in the gravity direction and then extended a predetermined distance to open the connecting part 94 above the mixing part 92 in the gravity direction. Then the reforming fuel supply, pipe 41 is connected to an opening part of the connecting part 94. Therefore, the possibility that the reforming water flows into the reforming fuel supply pipe 41 and then into the desulfurizer 46 provided in the upstream of the reforming fuel supply pipe 41 to damage the desulfurizing material can be reduced, improving the reliability of the apparatus.

Furthermore, because the possibility that the reforming water flows into the desulfurizer 46 provided in the upstream of the reforming fuel supply pipe 41 to cause damage is low, the degree of freedom for disposing the desulfurizer 46 increases. Therefore, the desulfurizer 46 can be freely disposed in a place where it can be maintained well, improving merchantability.

In addition, in the first embodiment, the reforming part 21 provided with the reforming catalyst is disposed above the mixing part 92 for mixing the reforming fuel and the steam, in the gravity direction. Therefore, the possibility that the drain water that is generated in the steam supply pipe 51 or the reforming fuel connecting pipe 93 flows into the reforming part 21 and the reforming catalyst after the operation is stopped can be reduced, and thus the possibility of deterioration of the reforming catalyst is also reduced, improving the reliability of the apparatus.

In the first embodiment, the carbon monoxide reduction part 23 that is supplied with the reforming gas from the reforming part 21 and reduces the carbon monoxide contained in the reforming gas is disposed below the pool part 91 in the gravity direction, and the upper part of the carbon monoxide reduction part 23 abuts against the pool part. Accordingly, the water of the pool part 91 abutting against the upper part of the carbon monoxide reduction part 23 is evaporated by the heat of the carbon monoxide reduction part 23, generating steam easily. As a result, the heat transfer efficiency is improved. Moreover, the water accumulated in the pool part 91 can reduce the temperature of the carbon monoxide reduction part 23 easily so that the inlet temperature of the carbon monoxide reduction part 23 can be brought close to the temperature at which a shift reaction takes place efficiently, improving the shift reaction efficiency.

Moreover, the cooling part 22, which cools the reforming gas fed from the reforming part 21 to the carbon monoxide reduction part 23 and heats the mixing gas of the reforming fuel and the steam mixed by the mixing part 92 and supplied to the reforming part 21 is provided between the reforming part 21 and the carbon monoxide reduction part 23. The mixing part 92 is provided between the cooling part 22 and the carbon monoxide reduction part 23. Therefore, this embodiment can form a simple configuration of a system that uses the reforming gas of relatively high temperature to increase the temperature of the mixed gas of the reforming fuel and the steam that is supplied to the reforming part 21 having relatively high reaction temperature (for example, 400° C. to 900° C.), and that also uses the mixed gas of relatively low temperature that is a mixture of the reforming fuel and the steam, to reduce the temperature of the reforming gas supplied to the carbon monoxide reduction part 23 having relatively low reaction temperature (for example, 150° C. to 250° C. or preferably 170° C. to 220° C.). As a result, cost reduction can be achieved.

A second embodiment of the reforming apparatus according to the invention is described next. The second embodiment is partially different from the first embodiment. Therefore, only the difference will be described, and the like reference numerals are used to indicate the like parts so as to omit the overlapping detailed description.

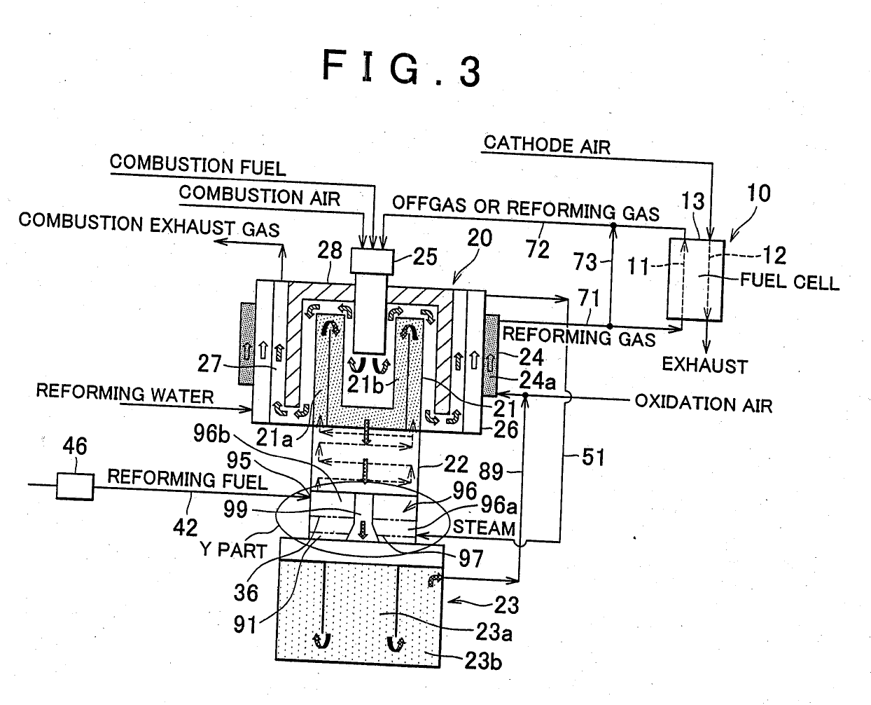

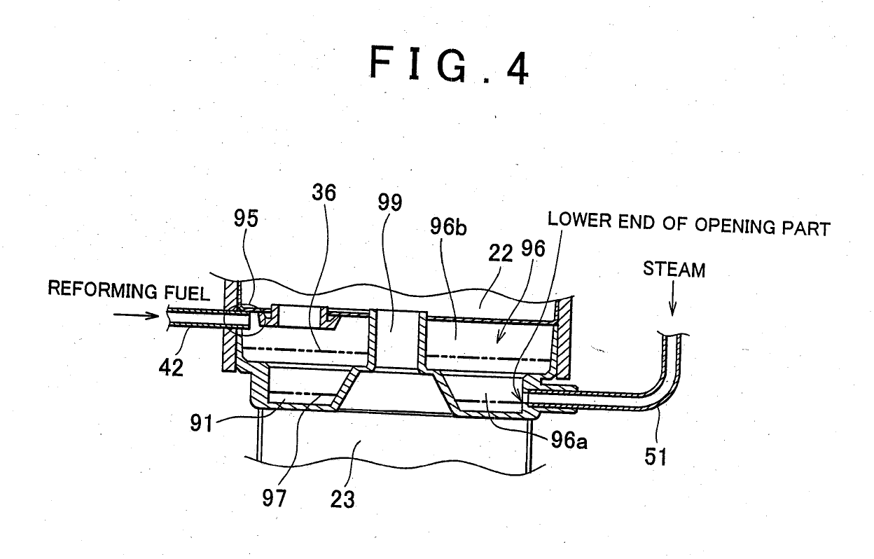

As shown in FIGS. 3 and 4, in the second embodiment of the invention, a mixing part 96 is formed between the cooling part 22 and the CO shift part 23. The mixing part. 96 is configured by a first mixing chamber 96a positioned on the lower side in the gravity direction and a second mixing chamber 96b positioned on an upper end (two-dot chain line) 36 of the first mixing chamber 96a. The steam supply pipe 51 connected to the evaporation part 26 is connected and opened to the first mixing chamber 96a so that the steam and water are supplied thereto from the evaporation part 26. A reforming fuel supply pipe 42 connected to the fuel supply source (for example, city gas pipe) is directly connected to the second mixing chamber 96b without the use of the reforming fuel connecting pipe 93, and the reforming fuel input port 95 is opened to the second mixing chamber 96b. The reforming fuel is supplied from the reforming fuel input port 95 and mixed with the steam in the mixing part 96. A lower part of the mixing part 96 in the gravity direction is provided with the pool part 91 for accumulating the water that is supplied along with the steam from the evaporation part 26 via the steam supply pipe 51. As in the first embodiment, the height of the pool part 91 is set by obtaining the maximum amount of the water to be accumulated by using demonstration data, and then obtaining a volume that can accumulate the maximum amount obtained based on the data. The pool part 91 projects downward from a bottom part of the mixing chamber 96a of the mixing part 96 in the gravity direction, the mixing part 96 being disposed on the lower side of the reforming part 21 with the reforming catalyst in the gravity direction. As shown in FIG. 4, a space 99 penetrating vertically is provided in the center between the mixing part 96 and the pool part 91 so that the reforming gas generated in the reforming part 21 is guided out to the CO shift part 23. An upper section of a circular space formed circularly around a rim part of the penetrating space 99 in the gravity direction configures the mixing chambers 96a and 96b of the mixing part 96, while a lower section in the gravity direction configures the pool part 91 and abuts against the CO shift part 23.

The connection position between the steam supply pipe 51 and the mixing chamber 96a of the mixing part 96 is formed such that a lower end of an opening part of the steam supply pipe 51 opened to the mixing chamber 96a in the gravity direction is positioned above the upper end (two-dot chain line) 97 of the pool part 91 in the gravity direction. The reforming fuel input port 95 obtained by opening the reforming fuel supply pipe 42 to the mixing chamber 96b of the mixing part 96 is connected so as to be positioned above the opening part of the steam supply pipe 51 opened to the mixing chamber 96a in the gravity direction (FIG. 4). Then, the mixed gas of the steam and the reforming fuel that is obtained in the mixing part 96 (the mixing chambers 96a and 96b) is supplied to the reforming part 21 via the cooling part 22.

As is clear from the above description, in the second embodiment, because the reforming fuel input port 95 obtained by opening the reforming fuel supply pipe 42 to the mixing chamber 96b is disposed above an feed port of the steam supply pipe 51 opened to the mixing chamber 96a in the gravity direction, the possibility that the reforming water flows into the reforming fuel supply pipe 42 via the reforming fuel input port 95 is low. Therefore, regardless of how an upstream section of the reforming fuel input port 95 or, in other words, the reforming fuel supply pipe 42 is disposed, the possibility that the reforming water flows back to the reforming fuel supply pipe 42 is low. Consequently, the possibility that the reforming water flows into the desulfurizer 47 provided in the upstream of the reforming fuel supply pipe 42 to damage the desulfurizing material or deteriorate the desulfurizer 47 can be reduced, improving the reliability of the apparatus.

As described above, the possibility that the reforming water flows into the desulfurizer 47 of the reforming fuel supply pipe 42 to cause damage is low. Therefore, the risk of deterioration caused by the water can be lowered, increasing the degree of freedom for disposing the desulfurizer 47. Therefore, the desulfurizer 47 can be freely disposed in a place where it can be maintained well, improving merchantability.

In addition, in the second embodiment, the feed port for feeding the steam and the reforming fuel input port 95 are disposed in the gravity direction below the reforming part 21 provided with the reforming catalysts. Therefore, the possibility that the drain water that is generated in the steam supply pipe 51 or the reforming fuel supply pipe 42 flows into the reforming part 21 and the reforming catalyst to deteriorate the reforming catalyst after the operation is stopped can be reduced, improving the reliability of the apparatus. The same effects as those of the first embodiment can be expected in other configurations of this embodiment.

The above has described the embodiments of the invention, but the invention is not limited to these embodiments, and it should be appreciated that various modifications can be made without departing from the scope of the invention.

1. A reforming apparatus comprising:
an evaporation part that heats reforming water to generate steam;
a mixing part that mixes reforming fuel with the steam;
a reforming part having a reforming catalyst that is supplied with the reforming fuel mixed with the steam and generates reforming gas from the supplied reforming fuel, and disposed on the upper side of the mixing part in a gravity direction;
a reforming fuel supply pipe that has a desulfurizer for removing a sulfur content of the reforming fuel; and
a reforming fuel connecting pipe that is connected at one end to the reforming fuel supply pipe and opened at the other end to the mixing part,
wherein a connecting part between the reforming fuel supply pipe and the reforming fuel connecting pipe is disposed above the mixing part in the gravity direction.

2. The reforming apparatus according to claim 1, wherein a pool part that accumulates water supplied along with the steam and/or water obtained by liquefying the steam is provided on the lower side of the mixing part in the gravity direction.

3. The reforming apparatus according to claim 1, wherein a reforming fuel input port of the reforming fuel connecting pipe that is opened to the mixing part is disposed above the pool part in the gravity direction.

4. The reforming apparatus according to claim 2, wherein a carbon monoxide reduction part which is fed with the reforming gas from the reforming part to reduce carbon monoxide of the reforming gas is disposed below the pool part in the gravity direction, and an upper part of the carbon monoxide reduction part abuts against the pool part.

5. A reforming apparatus comprising:
an evaporation part that heats reforming water to generate steam;
a mixing part that mixes reforming fuel with the steam;
a reforming part having a reforming catalyst that is supplied with the reforming fuel mixed with the steam and generates reforming gas from the supplied reforming fuel, and disposed on the upper side of the mixing part in a gravity direction;
a reforming fuel supply pipe that has a desulfurizer for removing a sulfur content of the reforming fuel and supplies the reforming fuel to the mixing part; and
a steam supply pipe for supplying the steam generated by the evaporation part to the mixing part,
wherein a reforming fuel input port of the reforming fuel supply pipe that is opened to the mixing part is disposed, in the gravity direction, above a feed port of the steam supply pipe that is opened to the mixing part.

6. The reforming apparatus according to claim 5, wherein a pool part that accumulates water supplied along with the steam and/or water obtained by liquefying the steam is provided on the lower side of the mixing part in the gravity direction.

7. The reforming apparatus according to claim 6, wherein the reforming fuel input port of the reforming fuel supply pipe that is opened to the mixing part is disposed above the pool part in the gravity direction.

8. The reforming apparatus according to claim 6, wherein a carbon monoxide reduction part which is fed with the reforming gas from the reforming part to reduce carbon monoxide of the reforming gas is disposed below the pool part in the gravity direction, and an upper part of the carbon monoxide reduction part abuts against the pool part.

9. A reforming apparatus comprising:
an evaporation part that heats reforming water to generate steam;
a mixing part that is supplied with a reforming fuel and the steam and then mixes the reforming fuel and the steam;
a reforming part that is disposed on the upper side of the mixing part in a gravity direction, and has a reforming catalyst that is supplied with the reforming fuel mixed with the steam and generates reforming gas from the reforming fuel mixed with the steam;
a desulfurizer that removes a sulfur content of the reforming fuel; and
a communication path that communicates the desulfurizer and the mixing part with each other via a position above a position where the steam is supplied to the mixing part, in the gravity direction,
wherein the reforming fuel from which the sulfur content is removed is supplied to the mixing part via the communication path.

10. The reforming apparatus according to claim 9, further comprising a steam supply pipe for supplying the steam generated by the evaporation part to the mixing part, wherein the position in the gravity direction that is above a position where the steam is supplied to the mixing part is a position where the reforming fuel is supplied in the mixing part.

11. The reforming apparatus according to claim 9, wherein a pool part for accumulating water is provided in the mixing part below a position where the steam is supplied and a position where the reforming fuel is supplied, in the gravity direction.

12. The reforming apparatus according to claim 9, further comprising a carbon monoxide reduction part which is disposed below the pool part in the gravity direction, an upper part of which abuts against the pool part, and which feeds the reforming gas from the reforming part to reduce carbon monoxide of the reforming gas.

13. The reforming apparatus according to claim 1, further comprising a cooling part which is provided between the reforming part and the carbon monoxide reduction part, cools the reforming gas fed from the reforming part to the carbon monoxide reduction part, and heats mixed gas of the reforming fuel and the steam that are mixed in the mixing part and supplied to the reforming part, wherein the mixing part is provided between the cooling part and the carbon monoxide reduction part.

14. A reforming fuel supply method of a reforming apparatus having: an evaporation part that heats reforming water to generate steam; a mixing part that is supplied with a reforming fuel and the steam and then mixes the reforming fuel and the steam; a reforming part that is disposed on the upper side of the mixing part in a gravity direction, and has a reforming catalyst that is supplied with the reforming fuel mixed with the steam and generates reforming gas from the reforming fuel mixed with the steam; and a desulfurizer that removes a sulfur content of the reforming fuel,
the reforming fuel supply method being characterized by comprising:
communicating the desulfurizer with the mixing part via a position above a position in the gravity direction where the steam is supplied to the mixing part; and
supplying the reforming fuel from which the sulfur content is removed, to the mixing part by communicating the desulfurizer with the mixing part.

15. The reforming fuel supply method according to claim 14, further comprising accumulating water in the mixing part below a position where the steam is supplied and a position where the reforming fuel is supplied, in the gravity direction, wherein the position in the gravity direction that is above a position where the steam is supplied to the mixing part is a position where the reforming fuel is supplied in the mixing part.

16. The reforming apparatus according to claim 5, further comprising a cooling part which is provided between the reforming part and the carbon monoxide reduction part, cools the reforming gas fed from the reforming part to the carbon monoxide reduction part, and heats mixed gas of the reforming fuel and the steam that are mixed in the mixing part and supplied to the reforming part, wherein the mixing part is provided between the cooling part and the carbon monoxide reduction part.

17. The reforming apparatus according to claim 9, further comprising a cooling part which is provided between the reforming part and the carbon monoxide reduction part, and which cools the reforming gas fed from the reforming part to the carbon monoxide reduction part, and heats mixed gas of the reforming fuel and the steam that are mixed in the mixing part and supplied to the reforming part, wherein the mixing part is provided between the cooling part and the carbon monoxide reduction part.
